(19) United States
(12) Patent Application Publication
(10) Pub. No.: US 2013/0078315 A1
(43) Pub. Date: Mar. 28, 2013

(54) EGGSHELL ANTIMICROBIAL AGENT AND METHOD OF USE

(71) Applicant: BIOSYNERGY, INC., ELK GROVE VILLAGE, IL (US)

(72) Inventors: Fred Suzuki, Arlington Heights, IL (US); J.B. Weatherspoon, Glen Ellyn, IL (US); Laurence C. Mead, Hoffman Estates, IL (US)

(73) Assignee: BIOSYNERGY, INC., ELK GROVE VILLAGE, IL (US)

(21) Appl. No.: 13/667,571

(22) Filed: Nov. 2, 2012

Related U.S. Application Data
(63) Continuation-in-part of application No. 11/108,584, filed on Apr. 18, 2005, now abandoned.
(60) Provisional application No. 60/638,548, filed on Dec. 22, 2004.

(51) Int. Cl. A01N 63/00; A01P 1/00

(52) U.S. Cl. 424/581

(57) ABSTRACT

Provided herein is a composition and a method for inhibiting bacterial growth.

### CROSS-REFERENCE TO RELATED APPLICATIONS

This application is a continuation-in-part application of U.S. application Ser. No. 11/108,584, filed on Apr. 18, 2005, which claims priority from U.S. Provisional Patent Application Ser. No. 60/638,548, filed on Dec. 22, 2004, each of which is hereby incorporated by reference in its entirety.

### FIELD OF THE INVENTION

The present invention relates to a composition and method for protecting poultry from the growth of bacteria [and yeast].

### BACKGROUND

The Centers for Disease Control and Prevention (CDC) estimates that 76,000,000 cases of food borne illness occur annually and claim approximately 5,000 deaths and costs 7.7 billion dollars or more. Disease causing bacteria can accidentally contaminate meat, dairy products, fruits and vegetables at any stage, from the field to processing and storage. The safety of food is a prime concern of government officials. Food borne pathogens cost 325,000 hospitalizations yearly, according to the CDC. In fact, a recent government administration issued a “no tolerance” edict for Listeria monocytogenase in processed and ready-to-eat foods, such as hot dogs. Listeria is one of the deadliest of biological food contaminants, with a fatality rate of about 20%. Food borne illness often presents itself as flu-like symptoms, such as nausea, vomiting, diarrhea or fever, so many people may not recognize the illness is caused by bacteria or other pathogens in food.

The present invention addresses issues concerning food safety by using a byproduct or waste product of the food industry, which incurs disposal costs and problems and, at best, minimal value added to some products. The nation's egg processing and hatching industries generate nearly 190,000 tons of shells annually. There is a great need for the food processing industry to find alternative methods for processing and using eggshells in a way that is beneficial to the environment. Typically, the disposal of eggshells from egg processing plants and hatcheries has been addressed to incur the least cost for disposal. The following processes have been used over time to dispose of eggshell and hatchery waste and/or have been processed into a by-product of some use:

Landfilling has been used in limited cases in some states, but for the most part, this method of eggshell disposal is merely an option, for it is not allowed in many states.

When land application of eggshell is utilized, there are problems. Eggshells contain approximately 20 to 35% calcium, which acts as a buffer for the soil, however, the odor of the eggs is strong and unpleasant.

The shells may be rendered to a meal and recycled as a portion of a poultry diet. There is evidence that this is a corrosive process, with a high process equipment maintenance cost. There is reluctance on the part of some nutritionists to use the product in feed formulations.

Dehydration of eggshells is used in some areas of the United States to make a shell meal. However, proper air scrubbing devices are needed in order to inhibit odors from the environment.

Extrusion of eggshells is also used to produce shell/hatchery meal. A carrier is needed in the extrusion process, such as soybean meal, to reduce the moisture content of the eggshell/hatchery waste and to provide friction in the process. The friction assists in elevating temperatures in the extruder and the resulting heat wave destroys pathogens and viruses which may be in the eggshell/hatchery waste and cooks the material under pressure. This product is fed to poultry.

Spin separation of eggshells and hatchery waste is used wherein the eggshell/hatchery waste is collected and spun, with 50% of the liquid being removed and used as a protein source in pet foods. Eggshells remain and must be disposed of in some manner.

Composting of eggshell/hatchery waste can be used wherein the spin-separated eggshell/hatchery waste is composted and utilized in making potting soil mixes and used in organic farming wherein high levels of calcium are required.

While the foregoing methods of utilizing eggshell and hatchery waste are known, it is not known to use treated eggshells as an antimicrobial agent to inhibit the growth of bacteria for food borne illness.

U.S. Pat. No. 5,811,147 issued to Yamada discloses a preservative for food and beverages comprising calcium which is dissolved in a fermented solution of vinegar, alcohol and a fermenting agent, such as acetic acid. The source of the calcium may be eggshells, scallop shells, clamshells, oyster shells, coral, animal bones, fish bones, etc. The calcium component is dissolved in vinegar so that it is present in the amount of 3000 mg to 4000 mg for each 100 to 200 cc of fermented solution. Prior to dissolution, the calcium component comprises a powder having a particle size not exceeding 30 mm. The invention does not require the use of a fermenting solution.

Japanese Patent Application 01-91765 was published on Jun. 22, 1993 and discloses a preservative for food and drink containing the shells of short-neck clams, oysters, etc., which are crushed and dissolved in edible vinegar to obtain a preservative for use in food products.

U.S. Pat. No. 2,419,822 issued to Contesso describes a process for production of calcium carbonate from eggshells. Eggshells are placed in a drum having rotating internal blades which crush the shells in the presence of hot water. Rotation of the blades is stopped and the drum is drained of water and impurities, and subsequently the drum is closed and the blades are rotated again with the admission of hot air to dry the eggshells. The crushed shells are then removed and ground under oxygen to produce a dry bacteria free product.

U.S. Pat. No. 5,409,714 to lshijima describes an antimicrobial agent containing a calcined calcium oxide prepared by calcining shells of an oyster and/or a calcined product of a calcium hydroxide or hydrated product of a calcium hydroxide. The particle size of the product is less than or equal to 74 μm. It can be applied to processed food in a liquid state ranging in amounts from 0.05% to 10% by weight, preferably the amounts range from about 0.5% to about 1.0%. It can be sprayed on foods. It may also be applied to raw foods and added to salt water so that food particles may be immersed therein. The product comprises a combination of a calcined calcium oxide and calcined calcium hydroxide. The ratio of the type of calcium oxide ranges from 3 to 7 parts to approximately 7 to 3 parts, preferably 4 to 6 parts to 6 to 4 parts. The calcined product exhibited favorable MIC for many types of bacteria including S. typhimunium, S. enteritides, E. coli, S. aureus and B. subtilis.

The present invention provides an improvement over the use of oyster shells as a source for calcined calcium for inhibiting the growth of yeast and hazardous microorganisms on food.

### SUMMARY OF THE INVENTION

The present invention relates to a calcined eggshell composition, which is a result of heating the eggshell to a specific temperature. The eggshell composition may contain calcined eggshell particles having a particle size of about 1 μm to about 50 μm. The calcined eggshell exhibits antimicrobial action against pathogenic organisms that cause food borne illness, for example. The temperature may be about 625° C., about 700° C., about 800° C., about 900° C., or about 1000° C. to 1200° C.,

It is an object of present invention to provide an antimicrobial agent that is safe and effective against pathogenic organisms which are known to cause a food borne illness.

Another object of the present invention is to provide calcined eggshells as an antimicrobial agent.

Another object of the present invention is to provide a method of inhibiting the growth of pathogenic organisms which cause food borne illness.

Another object of the present invention is to provide an alternative to conventional practices of disposing of eggshells.

Other objects, features and advantages of the present invention can be derived from the description. The above-mentioned features and those which are further described below can be likewise utilized in accordance with the invention.

The present invention also relates to a method of inhibiting the growth of bacteria on an animal. The method comprises contacting the animal with an effective amount of a calcined chicken eggshell composition. The contact may be direct or indirect. The animal may be poultry, such as a chicken. The animal may be rinsed with an effective amount of a solution of the calcined chicken eggshell. The animal may be an animal carcass, such as a poultry carcass. The carcass may be immersed in the calcined eggshell composition or solution. The eggshell composition may be applied to the feet of the animal, such as the feet of poultry (e.g. a chicken). The feet may come into contact with the eggshell has been applied to the floor of an animal coup or applied to litter in the animal coup. An effective amount of the calcined eggshell composition may be from 0.03% and 0.5% of calcined eggshell in water. The effective amount of the calcined eggshell composition may be 0.08% of calcined eggshell in water. The calcined eggshell composition may comprise free iodine. The herein described method may use a calcined eggshell composition that has a pH of from 8.0 to about 8.7. The calcined eggshell composition may further contain an antibiotic, an antiviral, or a combination thereof. The calcined eggshell composition may result from calcining eggshell at 625° C. for 1 hour.

### BRIEF DESCRIPTION OF THE DRAWINGS

FIG. 1 shows the antimicrobial effects of calcined chicken eggshells at different temperatures.

FIG. 2 is a graph that shows the production of various antimicrobial components at various calcining temperatures and pH values.

### DETAILED DESCRIPTION

The inventors have made the surprising discovery that calcined chicken eggshells exhibit excellent antimicrobial activity and may be used to aid in the appropriate management and sanitation practices related to animal care. For example, the calcined chicken eggshells may be used to inhibit the growth of bacteria on an animal or the growth of bacteria in and around the animal's surroundings, such as a coup or litter. The calcined chicken eggshell may be contacted with the animal or it surroundings in an effective amount to inhibit the growth of the bacteria.

### 1. DEFINITIONS

The terminology used herein is for the purpose of describing particular embodiments only and is not intended to be limiting. As used in the specification and the appended claims, the singular forms “a,” “and” and “the” include plural references unless the context clearly dictates otherwise.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. CALCINED EGGSHELL COMPOSITION

The antimicrobial agent of the present invention comprises eggshells. By eggshells it is meant shells from the egg processing industry, namely eggshells from laying hens. The eggshells are heated to a high temperature or calcined to produce the product of the present invention. By calcination, it is meant heating of a solid to a temperature below its melting point to bring about a state of thermal decomposition or a phase transition other than melting. Included are the following types of reactions: thermal dissociation, polymorphic phase transitions and thermal recrystallization.

The eggshells utilized in the present invention have the yolk and generally the albumin removed. They are then rinsed with water and dried prior to calcination. Alternatively, the eggshells may not be rinsed and merely dried at room temperature before calcination. There is no need to reduce the size of the shells by additional breaking or grinding. The calcined eggshell may be prepared by heating the shells at high temperatures of 600° C. or higher, 700° C. or higher, 800° C. or higher, or 900° C. or higher. The eggshell may calcined at from about 1000° C. to about 1200° C. At preparation temperatures of from about 600° C. to 700° C., Applicant has discovered that iodine is released from various proteins in the eggshell. This free iodine imparts antimicrobial effects to the calcined eggshell composition. The Applicant has also discovered that magnesium oxide is produced in eggshell that is calcined at temperatures of about 700° C., that calcium oxide is produced in eggshell that is calcined at temperatures of from 825° C. to about 925° C., that potassium oxide is produced in eggshell that is calcined at temperatures at about 910° C., and that sodium oxide is produced in eggshell that is calcined at temperatures at about 850° C. Each of these components (magnesium oxide, calcium oxide, potassium oxide, and sodium oxide) can impart antimicrobial effects to the calcined eggshell composition. The calcined eggshell may have a pH of 8.0 or greater, 8.96 or greater, 10.99 or greater, 11.97 or greater, 12.40 or greater, 12.46 or greater. The eggshell composition that has free iodine, may have a pH of between from 8.0 and to 8.96. The eggshell composition that has magnesium oxide may have a pH value of between 8.75 and 9.2. The eggshell composition that has calcium oxide may have a pH value of between about 11 and 12.4. The eggshell composition that has sodium oxide may have a pH value of between 11 and 12. The eggshell composition that has potassium oxide may have a pH value of between 11.9 and 12.4.

The time of calcination must be sufficient to allow for thermal dissociation, including destructive distillation of organic compounds, the creation of a polymorphic phase transition and thermal recrystallization. Typically, the time of calcination is about one hour. More that one hour may result in the vaporization of antimicrobial components, such as iodine, produced as a product of the calcining method. The heating unit may be any conventional oven used for calcining at high temperatures. The source of the heat is immaterial.

The result of the decomposition and subsequent removal of the organic materials of the shell by calcining causes the product to be a white or off-white powder. It is not necessary to subject the powder to particle size diminution, for the resulting average particle size of the calcined eggshell is about 1 μm to about 50 p.m. About 61.5% of the product has a particle size ranging from about 1 μm to about 15 μm. About 38.5% of the product has a particle size ranging from about 15 μm to about 40 μm.

The calcined product contains calcium oxide as the primary ingredient. It is present in the amount of about 94.5% by weight. The pH of an aqueous solution of the eggshell particles may range from about 12 to about 13. The pH of a 1.0% solution and a 0.5% solution is about 12.2.

a. Other Ingredients

The calcined eggshell may contain other ingredients, besides calcium oxide, possibly metals or heavy metals, or other materials that may increase its antimicrobial value. The ingredients may be inherent in the calcined eggshell or they may be exogenously added to the eggshell composition. Ingredients may be added to the eggshell. Such ingredients may include antibiotics and/or antiviral compounds, acidified sodium chlorite, trisodium phosphate, chlorine dioxide, hypochlorous acid, organic acids, peracetic acid, cetylpyridinium chloride, citric acid and hydrochloric acid, bromine, sodium metasilcate, electrolyzed oxidative water, monochloramine, and SteriFx® (FreshFx®), for example. By antimicrobial, it is meant the bacteriostatic or bacteriocidal or preservative nature of the calcined eggshell when applied to food by way of its action on pathogenic organisms that cause food borne illness. By “pathogenic organisms”, it is meant both bacteria and yeast that cause food borne illnesses in humans.

An analysis of ingredients in calcined oyster and eggshell is found below in Table 1.

TABLE 1

| | Oyster Shell | | Eggshell | |
|---|---|---|---|---|
| Assay | Analysis | Units | Analysis | Units |
| PH | 12.2 | | 12.1 | |
| Arsenic | <3.0 | PPM | <3.0 | PPM |
| Antimony | <.10 | PPM | <.10 | PPM |
| Heavy Metals | <20 | PPM | <20 | PPM |
| Lead by Graphite | 97 | PPB | 171 | PPB |
| Furnace | | | | |
| Mercury | <.025 | PPM | 025 | PPM |
| Selenium | <.050 | PPM | .066 | PPM |
| Silver | 8.54 | PPM | 8.29 | PPM |
| Sulfur | <.025 | % | 0.34 | % |
| Tin | <500 | PPM | <500 | PPM |
| Aluminum | 540 | PPM | <20 | PPM |
| Barium | 8.95 | PPM | 30.9 | PPM |
| Beryllium | <5 | PPM | <5 | PPM |
| Cadmium | <5 | PPM | <5 | PPM |
| Calcium | 637000 | PPM | 655000 | PPM |
| Chromium | <10 | PPM | <10 | PPM |
| Cobalt | <5 | PPM | <5 | PPM |
| Copper | <2.5 | PPM | <2.5 | PPM |
| Iron | 299 | PPM | 10 | PPM |
| Magnesium | 4180 | PPM | 5440 | PPM |
| Manganese | 20.4 | PPM | <1.5 | PPM |
| Nickel | <4 | PPM | <4 | PPM |
| Phosphorous | 144 | PPM | 1470 | PPM |
| Potassium | <500 | PPM | <500 | PPM |
| Sodium | <500 | PPM | 610 | PPM |
| Strontium | 366 | PPM | 352 | PPM |
| Vanadium | <5 | PPM | <5 | PPM |
| Zinc | 2.74 | PPM | 3.04 | PPM |

(1) Antibiotic

The antibiotic may be any antibiotic. The antibiotic may be ampicillin, amoxicillin/clavulanate, metronidazole, clindamycin, erythromycin, gentamicin, vancomycin, ciproflaxin, clindamycin, tetracycline, an anxiolytic, amikacin, kanamycin, neomycin, netilmicin, streptomycin, tobramycin, teicoplanin, vancomycin, azithromycin, clarithromycin, clarithromycin, dirithromycin, erythromycin, roxithromycin, troleandomycin, amoxicillin, ampicillin, azlocillin, carbenicillin, clozacillin, dicloxacillin, flucozacillin, mezlocillin, nafcillin, penicillin, piperacillin, ticarcillin, bacitracin, colistin, polymyxin B, ciprofloxacin, enoxacin, gatifloxacin, levofloxacin, lomefloxacin, moxifloxacin, norfloxacin, oflazacin, trovafloxacin, mafenide, sulfacetamide, sulfamethizole, sulfasalazine, sulfisoxazole, trimethoprim, cotrimoxazole, demeclocycline, soxycycline, minocycline, doxycycline, or oxytetracycline.

(2) Antiviral

The antiviral compound may be any antiviral. The antiviral compound may be abacavir, acyclovir, adefovir, amantadine, amprenavir, ampligen, arbidol, atazanavir, atripla, boceprevir, cidofovir, darunavir, delavirdine, didanosine, docosanol, edoxudine, efavirenz, emtricitabine, enfuvirtide, entecavir, famcyclovir, fomivirsen, fosamprenavir, gancyclovir, ibacitabine, immunovir, idoxuridine, imiquimod, indinavir, lamivudine, lopinavir, loviride, maraviroc, moroxydine, pencyclovir, peremivir, pleconaril, ribavirin, ritonavir, saquinavir, telaprevir, tenofovir, truvada, valacyclovir, valgancyclovir, or zanamivir. The antiviral may be an poultry-acceptable antiviral.

In accordance with the present invention, the calcined eggshell product of the present invention may be applied to animals, coups, litter, and/or animal derived food products as a powder or aqueous solution. If the powder is placed in solution, a saturated solution is preferred. A preferred application is a powder wherein it may applied directly to the surface of the food article. The use of the calcined eggshell of the present invention has been determined by its activity against a representative sampling of pathogenic organisms known to cause food borne illness, for example, Pseudomonas aeruginosa, Listeria monocytogenes; Yeast-Saccharomyces cerevisiae, Zygosaccharmoyces balii and Candida albicans; Lactic Acid Bacteria-Lactobacillus fructivorans, and Lactobacillus brevis and E. coli.

### 3. METHOD OF INHIBITING BACTERIAL GROWTH

Provided herein is a method of inhibiting bacterial growth on an animal and/or surrounding environment, such as litter in a chicken house or coup. An effective amount of the eggshell composition may be contacted with the animal and/or surrounding environment. For example, bacterial-related diseases and conditions affecting chickens often impact the market for chickens. Footpad dermatitis (FPD) is a type of contact dermatitis on the footpad and toes. Every year the U.S. poultry industry, for example, loses hundreds of millions of dollars because of downgraded and condemned paws, most of which are due to FPD lesions. FPD may also be an indicator of bird welfare.

An effective amount of the eggshell composition may be from 0.02% to 5.0%, from 0.03% to 4%, from 0.04% to 35, from 0.03% and 0.5%, from 0.05% to 2%, from 0.06% to 1%, from 0.07% to 0.5%, from 0.08% to 0.25%, from 0.09% to 0.15%, from 0.1% to 0.125%, from 0.07% to 0.09%, or from 0.06% to 0.1% of calcined eggshell in an aqueous mixture. The aqueous mixture may be water alone or water with one or more other ingredients. An effective amount of the eggshell composition may be 0.05%, 0.06%, 0.07%, 0.08%, 0.09%, or 0.1% of the eggshell in an aqueous mixture. The aqueous mixture may be water alone or water with one or more other ingredients. The water may be distilled water. The aqueous mixture may contain amounts of eggshell product ranging from about 0.125% to about 1.0% of the liquid. When the animal or animal-derived food products are immersed in an aqueous mixture of the eggshell product, the eggshell product may be present in amounts ranging from 0.125% to 1.0% of the liquid.

a. Animal

The animal may be any animal. The animal may be of the poultry type. The poultry type animal may be a laying breed, a meat-producing breed, or a dual-purpose breed. The laying breed may be a White Leghorn, a Red Sex Link, or a Black Sex Link breed. The meat-producing breed may be a Cornish breed, for example. The Cornish game hen, for example, may be a cross between the Cornish and the New Hampshire or Plymouth Rock breeds. A meat-producing chicken may be a broilers or a fryer. The dual-purpose breed may be a backyard chicken. The backyard chicken may lay large brown-shelled eggs. Examples include Rhode Island Red and New Hampshire breeds.

Other types of poultry include the squab, goose, and duck. The poultry type can be a landfowl, waterfowl, or game type, for example. Other animals include, but are not limited to turkeys, geese, ducks and pheasants.

The animal may have been killed. The animal may be an animal carcass. The animal may have been previously processed or undergoing processing. The processing procedure may include killing, scalding, picking, and/or singeing the animal. The processing may further include eviscerating (removal of internal organs). The processing may also include washing, chilling and packaging the animal or meat from the animal.

b. Eggshell Composition Contact with the Animal

The eggshell composition may be contacted with the animal by any means, such as by spray and/or by immersing the animal in a solution of the composition. The mode of contact with the animal may be such that the eggshell composition is applied topically to the animal. At any point during processing the eggshell composition may be contacted with the animal. For example, a carcass can be chilled by placing it in a container of cold tap water that is overflowing continuously at a slow rate or periodically changed. The eggshell may be mixed into the water. This type of chilling will cool the carcass to water temperature and further inhibit bacterial growth on the carcass. Poultry carcasses may be chilled in ice and water to lower the temperature of the carcasses to a desired temperature before packing. Smaller birds may be chilled in a couple of hours. Turkeys and large capons or roasters will require several hours before they reach this temperature. The chilled carcasses may be removed from the ice water mixture and hung by a wing, for example, to let drain before placing the carcasses in bags for transport or storage.

The eggshell may be applied to a live animal. The eggshell may be applied directly or indirectly. For example, the eggshell may be directly applied to the animal as described above (e.g. via rinsing or chilling). Alternatively, the eggshell may be applied to the animal indirectly, such as by mixing the eggshell with litter covering the floor of a coup.

The calcined eggshell composition may be applied to the animal in an aqueous mixture, for example, by spraying or immersion of the food product into the aqueous mixture. The immersion time is relatively short, for example, a number of seconds. The time of immersion may be from about 1 to about 10 seconds depending on the size of the food particle. If a large food particle is immersed in the aqueous mixture, it will require a longer immersion time than a smaller particle of food. The time of immersion may be from 10 seconds to 5 hours, from 30 seconds to 4 hours, from 1 minute to 3 hours, from 30 minutes to 2 hours, from 1 hour to 1.5 hours, or from 30 minutes to 1.5 hours. The time of immersion may be 1 minute, 10 minutes, 30 minutes, 1 hour, 2 hours, 3 hours, 4 hours, 5 hours, or longer.

The calcined eggshell product may be applied to various types of food. In this regard, “food” is intended to be any food, including processed food in liquid or solid state, raw meat from live stock, fish, raw fish meat, raw shellfish, vegetables, dairy products, edible roots, fruits, etc. The calcined egg product must be brought in contact with the food product as indicated above. The application of the eggshell product suppresses the growth of pathogenic organisms adhering to the surface of foods. The eggshell product therefore sterilizes the food, and prevents the food from decaying for long periods of time and therefore sustains the food with a long shelf life and high degree of freshness.

c. Eggshell Composition Contact with Coup or Litter

The eggshell composition may be contacted with, or applied to, the coup or litter by any means. The mode of contact with the coup or litter may be such that the eggshell composition is applied topically to the coup or litter. The eggshell composition may be sprayed, for example, onto the coup or litter. The coup or litter may then be allowed to dry. The coup may be sprayed with the eggshell composition via a poultry house washer sprayer, such as those marketed by the Kelley Manufacturing Co. in Tifton, Ga. Alternatively, the litter may be pre-coated with the eggshell composition. The litter may be soaked in an eggshell composition. The soaked litter may then be drained and dried for subsequent spreading in a coup.

The following examples illustrate the effectiveness of the calcined eggshell of the present invention. All parts and percentages are by weight. Standard testing was conducted. The present invention has multiple aspects, illustrated by the following non-limiting examples.

### EXAMPLES

### Example 1

### Calcined Eggshell

Eggshells from laying hens were calcined at approximately 900° C. for about one hour. The resulting calcined eggshell product had an average particle size of about 11 μm. The particles were found to have an analysis similar to the ingredients disclosed in Table 1. An aqueous solution of the calcined eggshells obtained in this example was utilized in the subsequent Examples 2 and 3.

### Example 2

### Inhibition of Growth of Pathogenic and Spoilage Organisms

The objective of this study was to assess the efficacy of two preservative systems in the inhibition of the growth of pathogenic and spoilage organisms in laboratory media.

### Background

Two products ESP-1 (Eggshell Power) of the instant invention and OP-1 (Oyster Shell Powder) established in Japan as a preservative for food and beverage products.

A challenge study was conducted in which the products were added at a concentration of 1%, 0.5%, 0.25% and 0.05% (w/w) into laboratory growth media and these solutions inoculated with typical spoilage and pathogenic organisms including Listeria monocytogenes, mold, yeast, lactic acid bacteria, Pseudomonas aeruginosa, Escherichia coli (0151-H7).

### Materials and Methods

Two glass screw cap vials with 10 g. each of test preservative were utilized. The method of Example 1 of the U.S. Pat. No. 5,409,714 was followed to prepare oyster shell powder, a known antimicrobial agent, and is identified as of OP-1. ESP-1 the product of the process of the present invention, was prepared in accordance with the procedures described in Example 1. Samples were stored at room temperature prior to the initiation of the study.

### Challenge Organisms

Samples were inoculated with the following composite cultures prepared from strains obtained from bioMerieux, Hazelwood, Mo.: A cell suspension was prepared for each strain, cell suspensions were mixed to prepare an inoculum which contained approximately equal numbers of cells of each strain, the number of viable cells or spores was verified by optical density confirmed by conventional plate count method.

| | bioMerieux |
|---|---|
| Organism | ATCC# |
| Pseudomonas aeruginosa | 21853 |
| Listeria monocytogenes | 1644 |
| Candida albicans (yeast) | 10231 |
| Lactobacullus brevis | 4366 |
| (lactic acid bacteria) | |
| Escheria coli (0151-H7) | 100128 |

### Preparation of Test Samples and Storage

For each challenge organism, 1.0, 0.5, 0.25, 0.125, 0.05% (w/w) of test preservative was added to growth medium* as listed below. The solutions were mixed thoroughly. A composite culture was added at 10-100 cfu/ml (colony forming units) of cultures. Solutions were incubated at 25-35° C. with daily immersion.

| Organism | Growth Medium |
|---|---|
| Pseudomonas aerugiriosa | Trypticase soy broth |
| Listeria monocytogenes | Trypticase soy broth (Plus) |
| Lactic acid bacteria | MRS broth |
| Yeast (Candida albicans) | Saboraud dextrose broth |
| E. coli (01 57-H7) | Fraser broth |

*Growth medium by bioMerieux (prepackaged, 16×125 mm) sc. Good quality glass tube for optical density (0.0 measurement)

### Sample Analyses

Samples of the control and inoculated portions were analyzed initially [Day 0] and Day 5. The method of analysis is outlined in the following table.

| | | Incubation/Time/ |
|---|---|---|
| | | Temperature |
| Test | Medium | Atmosphere |
| Listeria monocytogenes | Trypticase soy agar with | 2-Days/30° C./aerobic |
| | yeast | |
| Lactic acid Bacteria | Deman, Rogasa, Sharpe | 5-Days/25° C./aerobic |
| | (MRS/agar) | (plus) |
| Pseudomonas aeruginosa | Trypticase soy agar | 2-Days/30° C./aerobic |
| Yeast | Saboraud dextrose broth | 3-Da_ys/30° C./ |
| | | aerobic |
| E. coli (0157-H7) | Fraser broth | 2-Days/35° C./aerobic |

### Results and Discussion

A preservative is considered effective if it inhibits the growth of spoilage and/or pathogenic organisms in the specific test matrix. A challenge study was conducted and the two preservatives ESP-1 and OP-1 were added to growth media and the solutions with Pseudomonas, Listeria monocytogenes, yeast, lactic acid bacteria, and Escherichia coli (0157-H7).

Results are shown in Tables 2-6. As the data show, Listeria monocytogenes, Lactic acid, Pseudomonas aeruginosa, Yeast, and E. coli (0157-H7) did not increase in test samples with either 0.5 or 1.0% ESP-1 or OP-1 stored at 25-30° C. for 2-5 days. Also, the data show at 0.25% the test samples did not increase in Lactic acid, Pseudomonas aeruginosa, Yeast or E. coli (0157-H7). By contrast, inoculated control samples without test products showed 6-8 log increase in cells.

Therefore, the test products ESP-1 and OP-1 at concentrations of 0.125, 0.250, 0.50, and 1.0% were efficacious in the inhibition of spoilage and pathogenic organisms in laboratory growth media.

Finally, the ESP-1 (eggshell powder) product exhibited improved results over the OP-1 (oyster shell powder) product at 0.250, 0.125, and 0.05% in Listeria monocytogenes. ESP-1 also showed improved results at 0.125 and 0.05% in Lactic acid, Pseudomonas aeruginosa. With reference to Yeast, ESP-1 showed improved results over OP-1 with all levels. In the E. coli (0157-H7) test, the ESP-1 product showed improved results over OP-1 product at the 0.05% and 0.25% levels.

TABLE 2
EFFICACY OF PRESERVATIVES CHALLENGED WITH LISTERIS MONOCYTOGENES

| | | Positive | | | | | | |
|---|---|---|---|---|---|---|---|---|
| Interval | | Control | ESP-1 (1%) | OP-1 (1%) | ESP-1 (0.5%) | OP-1 (0.5%) | ESP-1 (0.25%) | OP-1 (0.25%) |
| Inoculum | Replicates | (cfu/ml) | (cfu/ml) | (cfu/ml) | (cfu/ml) | (cfu/ml) | (cfu/ml) | (cfu/ml) |
| Level | | 100 | 100 | 100 | 100 | 100 | 100 | 100 |
| Day 0 | 1 | 100 | 0 | 0 | 0 | 0 | <10 | <10 |
| | 2 | 95 | 0 | 0 | 0 | 0 | <10 | <10 |
| | 3 | 96 | 0 | 0 | 0 | 0 | <10 | <10 |
| Day 5 | 1 | 350,000,000 | <10 | <10 | <10 | <10 | <10 | <100 |
| | 2 | 525,000,000 | <10 | <10 | <10 | <10 | <10 | <100 |
| | 3 | 425,000,000 | <10 | <10 | <10 | <10 | <10 | <100 |

| | | Positive | | | | |
|---|---|---|---|---|---|---|
| Interval | | Control | ESP-1 (.125%) | OP-1 (0.125%) | ESP-1 (0.05%) | OP-1 (0.05%) |
| Inoculum | Replicates | (cfu/ml) | (cfu/ml) | (cfu/ml) | (cfu/ml) | (cfu/ml) |
| Level | | 100 | 100 | 100 | 100 | 100 |
| Day 0 | 1 | 100 | 59 | 100 | 63 | 100 |
| | 2 | 95 | 63 | 93 | 71 | 100 |
| | 3 | 96 | 68 | 96 | 73 | 99 |
| Day 5 | 1 | 350,000,000 | <100 | <50,000 | <100,000 | 175,000,000 |
| | 2 | 525,000,000 | <100 | <50,000 | <100,000 | 225,000,000 |
| | 3 | 425,000,000 | <100 | <50,000 | <100,000 | 315,000,000 |

TABLE 3
EFFICACY OF PRESERVATIVES CHALLENGED WITH LACTIC ACID

| | | Positive | | | | | | |
|---|---|---|---|---|---|---|---|---|
| Interval | | Control | ESP-1 (1%) | OP-1 (1%) | ESP-1 (0.5%) | OP-1 (0.5%) | ESP-1 (0.25%) | OP-1 (0.25%) |
| Inoculum | Replicates | (cfu/ml) | (cfu/ml) | (cfu/ml) | (cfu/ml) | (cfu/ml) | (cfu/ml) | (cfu/ml) |
| Level | | 1500 | 1500 | 1500 | 1500 | 1500 | 1500 | 1500 |
| Day 0 | 1 | 650 | <10 | <10 | <10 | <10 | <10 | <10 |
| | 2 | 610 | <10 | <10 | <10 | <10 | <10 | <10 |
| | 3 | 570 | <10 | <10 | <10 | <10 | <10 | <10 |
| Day 5 | 1 | 675,000,000 | <10 | <10 | <10 | <10 | <10 | <10 |
| | 2 | 925,000,000 | <10 | <10 | <10 | <10 | <10 | <10 |
| | 3 | 750,000,000 | <10 | <10 | <10 | <10 | <10 | <10 |

| | | Positive | | | | |
|---|---|---|---|---|---|---|
| Interval | | Control | ESP-1 (.125%) | OP-1 (0.125%) | ESP-1 (0.05%) | OP-1 (0.05%) |
| Inoculum | Replicates | (cfu/ml) | (cfu/ml) | (cfu/ml) | (cfu/ml) | (cfu/ml) |
| Level | | 1500 | 1500 | 1500 | 1500 | 1500 |
| Day 0 | 1 | 650 | 10 | 100 | 100 | 1000 |
| | 2 | 610 | 10 | 100 | 100 | 1000 |
| | 3 | 570 | 10 | 100 | 100 | 1000 |
| Day 5 | 1 | 675,000,000 | <100 | <100,000 | <1,000,000 | 2,100,000 |
| | 2 | 925,000,000 | <100 | <100,000 | <1,000,000 | <3,150,000 |
| | 3 | 750,000,000 | <100 | <100,000 | <90,000 | 2,650,000 |

TABLE 4
EFFICACY OF PRESERVATIVES CHALLENGED WITH PSEUDOMONAS

| | | | | | | OP-1 (0.25%) | |
|---|---|---|---|---|---|---|---|
| Interval | | Control | ESP-1 (1%) | ESP-1 (0.5%) | OP-1 (0.5%) | ESP-1 (0.25%) | |
| Inoculum | Replicates | (cfu/ml) | (cfu/ml) | (cfu/ml) | (cfu/ml) | (cfu/ml) | (cfu/ml) |
| Level | 20 | 50 | 50 | 50 | 50 | 50 | |
| Day 0 | 1 | 45 | 0 | 0 | 0 | 0 | |
| | 2 | 39 | 0 | 0 | 0 | 0 | |
| | 3 | 42 | 0 | 0 | 0 | 0 | |
| Day 5 | 1 | 680,000,000 | 0 | <10 | <10 | <10 | <10 |
| | 2 | 650,000,000 | 0 | <10 | <10 | <10 | <10 |
| | 3 | 790,000,000 | 0 | <10 | <10 | <10 | <10 |

| | | Positive | | | | |
|---|---|---|---|---|---|---|
| Interval | | Control | ESP-1 (.125%) | OP-1 (0.125%) | ESP-1 (0.05%) | OP-1 (0.05%) |
| Inoculum | Replicates | (cfu/ml) | (cfu/ml) | (cfu/ml) | (cfu/ml) | (cfu/ml) |
| Level | | 50 | 50 | 50 | 50 | 50 |
| Day 0 | 1 | 45 | 0 | 0 | 0 | <10 |
| | 2 | 39 | 0 | 0 | 0 | <10 |
| | 3 | 42 | 0 | 0 | 0 | 15 |
| Day 5 | 1 | 680,000,000 | 29 | <100 | <100 | <100,000 |
| | 2 | 650,000,000 | 20 | <100 | <100 | <100,000 |
| | 3 | 790,000,000 | 26 | <100 | <100 | <100,000 |

TABLE 5
EFFICACY OF PRESERVATIVES CHALLENGED WITH YEAST

| | | Positive | | | | | | |
|---|---|---|---|---|---|---|---|---|
| Interval | | Control | ESP-1 (1%) | OP-1 (1%) | ESP-1 (0.5%) | OP-1 (0.5%) | ESP-1 (0.25%) | OP-1 (0.25%) |
| Inoculum | Replicates | (cfu/ml) | (cfu/ml) | (cfu/ml) | (cfu/ml) | (cfu/ml) | (cfu/ml) | (cfu/ml) |
| Level | | 200 | 200 | 200 | 200 | 200 | 200 | 200 |
| Day 0 | 1 | 159 | 15 | 18 | 21 | 29 | 21 | 31 |
| | 2 | 100 | 13 | 29 | 19 | 20 | 23 | 29 |
| | 3 | 118 | 19 | 21 | 31 | 16 | 17 | 40 |
| Day 5 | 1 | 8,000,000 | <10 | <10 | <10 | <10 | <10 | <10 |
| | 2 | 12,000,000 | <10 | <10 | <10 | <10 | <10 | <10 |
| | 3 | 9,500,000 | <10 | <10 | <10 | <10 | <10 | <10 |

| | | Positive | | | | |
|---|---|---|---|---|---|---|
| Interval | | Control | ESP-1 (.125%) | OP-1 (0.125%) | ESP-1 (0.05%) | OP-1 (0.05%) |
| Inoculum | Replicates | (cfu/ml) | (cfu/ml) | (cfu/ml) | (cfu/ml) | (cfu/ml) |
| Level | | 200 | 200 | 200 | 200 | 200 |
| Day 0 | 1 | 159 | 35 | 37 | 39 | 29 |
| | 2 | 100 | 26 | 41 | 18 | 45 |
| | 3 | 118 | 21 | 31 | 27 | 51 |
| Day 5 | 1 | 8,000,000 | <10 | <100 | <1,000 | <200,000 |
| | 2 | 12,000,000 | <10 | <100 | <1,000 | <250,000 |
| | 3 | 9,500,000 | <10 | <100 | <1,000 | <150,000 |

TABLE 6
EFFICACY OF PRESERVATIVES CHALLENGED WITH ESCHERICHIA COLI (0157-H7)

| | | Positive | | | | | | |
|---|---|---|---|---|---|---|---|---|
| Interval | | Control | ESP-1 (1%) | OP-1 (1%) | ESP-1 (0.5%) | OP-1 (0.5%) | ESP-1 (0.25%) | OP-1 (0.25%) |
| Inoculum | Replicates | (cfu/ml) | (cfu/ml) | (cfu/ml) | (cfu/ml) | (cfu/ml) | (cfu/ml) | (cfu/ml) |
| Level | | 100 | 100 | 100 | 100 | 100 | 100 | 100 |
| Day 0 | 1 | 79 | <10 | <10 | <10 | <10 | 0 | <10 |
| | 2 | 81 | <10 | <10 | <10 | <10 | 0 | <10 |
| | 3 | 63 | <10 | <10 | <10 | <10 | <10 | <10 |
| Day 5 | 1 | 325,000,000 | <10 | <10 | <10 | <10 | <10 | <10 |
| | 2 | 496,000,000 | <10 | <10 | <10 | <10 | <5 | <10 |
| | 3 | 298,000,000 | <10 | <10 | <10 | <10 | <5 | <10 |

| | | Positive | | | | |
|---|---|---|---|---|---|---|
| Interval | | Control | ESP-1 (.125%) | OP-1 (0.125%) | ESP-1 (0.05%) | OP-1 (0.05%) |
| Inoculum | Replicates | (cfu/ml) | (cfu/ml) | (cfu/ml) | (cfu/ml) | (cfu/ml) |
| Level | | 100 | 100 | 100 | 100 | 100 |
| Day 0 | 1 | 79 | <10 | <10 | 49 | 67 |
| | 2 | 81 | <10 | <10 | 51 | 69 |
| | 3 | 63 | <10 | <10 | 59 | 80 |
| Day 5 | 1 | 325,000,000 | <10 | <10 | <100,000 | <150,000 |
| | 2 | 496,000,000 | <10 | <10 | <100,000 | <150,000 |
| | 3 | 298,000,000 | <10 | <10 | <100,000 | <150,000 |

### Example 3

### Functional Comparison Between ESP-1 and Oyster Shell Powder

### Objective

The objective of this study was to assess the efficacy of two preservative systems in inhibition of the growth of pathogenic and spoilage organisms in foods and laboratory media.

### Background

The product of the instant invention ESP-I (Eggshell Powder) was compared to OP-1 (Oyster Shell Powder), which is established in Japan as a food and beverage preservative. The eggshell powder was produced in accordance with the process described in Example 1. The oyster shell powder was prepared in accordance with the method of Example 1 of U.S. Pat. No. 5,409,714.

A challenge study was conducted in which the products were added at a concentration of 1%, 0.5%, 0.25%, 0.125%, and 0.05% (w/w) into laboratory growth media and these solutions inoculated with food products (beef, chicken, fish, cheese) that were previously inoculated with typical spoilage and pathogenic organisms including Listeria monocytogenes, lactic acid bacteria, Pseudomonas, yeast, Escherichia coli (01 57-H7)

### Materials and Methods

### Test Product

Two glass screw cap vials with 15.0 g each of test preservative “OP-1 020423” and ESP-I 031203 (BSI), samples were stored at room temperature prior to the initiation of the study.

### Challenge Organisms

Samples (chicken, beef, fish, cheese) were inoculated with the following composite cultures prepared from strains obtained from bioMerieux, Hazelwood, Mo. A cell suspension was prepared for each strain. Cell suspensions were mixed to prepare an inoculum which contained approximately equal number of cells of each strain. The number of viable cells or spores was verified by optical density (O.D) and confirmed by conventional ESTM plate count method.

| | bioMerieux |
|---|---|
| Organism | ATCC# |
| Listeria monocvtoqenes | 7644 |
| Lactobacullus brevis | 4366 |
| (lactic acid bacteria) | |
| Pseudomonas aeruqinosa | 27853 |
| Candida albicans (yeast) | 10231 |
| Escheria coli (0151-H7) | 700728 |

### Preparation of Test Samples and Storage

For each challenge organism on food products (chicken, beef, fish cheese), 1.0, 0.5, 0.25, 0.125, 0.05% (w/w) of test preservative was added to growth medium* as listed below. The solutions were thoroughly mixed (inverted for 5 minutes (SP-Inverto-Tek)). A composite culture was added at 50, 100, 200, 1500 cfu/ml (colony forming units) of cultures. Culture solutions were incubated at 25-35° C. daily.

| Organism* | Growth Medium |
|---|---|
| Listeria monocytogenes | Trypticase soy broth (Plus) |
| Lactic acid bacteria | MRS broth |
| Pseudomonas | Trypticase soy broth |
| Yeast | Saboraud dextrose broth |
| E. coli (01 57-H7) | Fraser broth |

*growth medium by bioMerieux (prepackaged, 16 × 125 mm) sc. Good quality glass tube for optical density (O.D) measurement.

### Sample Analysis

Samples of the control and inoculated portions were analyzed initially [Day 2] and Day 5. The method of analysis is outlined in the following table.

| | | Incubation/Time/ |
|---|---|---|
| | | Temperature |
| Test | Medium | Atmosphere |
| Listeria monocytogenes | Trypticase soy agar with | 2-Days/30° C./aerobic |
| | yeast | |
| Lactic acid Bacteria | Deman, Rogasa, Sharpe | 5-Days/25° C./aerobic |
| | (MRS/agar) | (plus) |
| Pseudomonas aeruginosa | Trypticase soy agar | 2-Days/30° C./aerobic |
| Yeast | Saboraud dextrose broth | 3-Da_ys/30° C./ |
| | | aerobic |
| E. coli (0157-H7) | Fraser broth | 2-Days/35° C./aerobic |

### Results and Discussion

Results are shown in Tables 7-12. As the data shows, Listeria monocytogenes stored at 30° C., Lactic acid stored at 25° C., Pseudomonas aeruginosa (on chicken and fish) stored at 30° C., Yeast stored at 30° C., and E coli (0157-H7) stored at 35° C. did not increase in test samples with either 0.5 or 1.0% ESP-1 031203 (BSI) or OP-1 020423 for 2-5 days. Also, the data shows at 0.25% the test samples did not increase in Lactic acid, Pseudomonas aeruginosa (on chicken and fish), yeast, or E. coli (0157-H7). By contrast, inoculated control samples without test products showed 6-8 log increase in cells.

Therefore, the test products ESP-1 031203 (BSI) and OP-1 020423 at concentrations of 0.125, 0.250, 0.50, and 1.0% were efficacious in the inhibition of growth of pathogenic and spoilage organisms in foods and laboratory media.

Finally, the ESP-1 031203 (BSI) product exhibited improved results over the OP-1 020423 product at 0.250, 0.125 and 0.05% in Listeria monocytogenes. ESP-1 031203 (BSI) also showed improved results at 0.125 and 0.05% in Lactic acid, Pseudomonas aeruginosa, and Yeast. In the E. coli (0157-H7) test, the ESP-1 031203 (BSI) product showed improved results over OP-1 020423 product at 0.05% level, and is an effective antimicrobial for food form pathogens and antimicrobial agent for food products.

TABLE 7
EFFICACY OF PRESERVATIVES CHALLENGED WITH LISTERIA MONOCYTOGENES OF FOOD (BEEF)

| | | Positive | | | | | | |
|---|---|---|---|---|---|---|---|---|
| Interval | | Control | ESP-1 (1%) | OP-1 (1%) | ESP-1 (0.5%) | OP-1 (0.5%) | ESP-1 (0.25%) | OP-1 (0.25%) |
| Inoculum | Replicates | (cfu/ml) | (cfu/ml) | (cfu/ml) | (cfu/ml) | (cfu/ml) | (cfu/ml) | (cfu/ml) |
| Level | | 100 | 100 | 100 | 100 | 100 | 100 | 100 |
| Day 0 | 1 | 100 | 0 | 0 | 0 | 0 | 0 | 0 |
| | 2 | 100 | 0 | 0 | 0 | 0 | 0 | 0 |
| | 3 | 90 | 0 | 0 | 0 | 0 | 0 | 0 |
| Day 5 | 1 | 395,500,000 | 0 | 0 | 0 | 0 | 0 | <100 |
| | 2 | 372,800,000 | 0 | 0 | 0 | 0 | 0 | <100 |
| | 3 | 368,100,000 | 0 | 0 | 0 | 0 | 0 | <100 |

| | | Positive | | | | |
|---|---|---|---|---|---|---|
| Interval | | Control | ESP-1 (.125%) | OP-1 (0.125%) | ESP-1 (0.05%) | OP-1 (0.05%) |
| Inoculum | Replicates | (cfu/ml) | (cfu/ml) | (cfu/ml) | (cfu/ml) | (cfu/ml) |
| Level | | 100 | 100 | 100 | 100 | 100 |
| Day 0 | 1 | 100 | <10 | 53 | <20 | 100 |
| | 2 | 100 | <10 | 87 | <20 | 99 |
| | 3 | 90 | <10 | 90 | <20 | 100 |
| Day 5 | 1 | 395,500,000 | <20 | 63,200 | 39,700 | 25,500,000 |
| | 2 | 372,800,000 | <20 | 70,100 | 68,500 | 19,800,000 |
| | 3 | 368,100,000 | <20 | 65,200 | 31,800 | 69,500,000 |

TABLE 8
EFFICACY OF PRESERVATIVES CHALLENGED WITH LACTIC ACID ON FOOD (CHEESE)

| | | Positive | | | | | | |
|---|---|---|---|---|---|---|---|---|
| Interval | | Control | ESP-1 (1%) | OP-1 (1%) | ESP-1 (0.5%) | OP-1 (0.5%) | ESP-1 (0.25%) | OP-1 (0.25%) |
| Inoculum | Replicates | (cfu/ml) | (cfu/ml) | (cfu/ml) | (cfu/ml) | (cfu/ml) | (cfu/ml) | (cfu/ml) |
| Level | | 1500 | 1500 | 1500 | 1500 | 1500 | 1500 | 1500 |
| Day 0 | 1 | 790 | <10 | <10 | <10 | <10 | <10 | <10 |
| | 2 | 805 | <10 | <10 | <10 | <10 | <10 | <10 |
| | 3 | 920 | <10 | <10 | <10 | <10 | <10 | <10 |
| Day 5 | 1 | 596,500,000 | <10 | <10 | <10 | <10 | <10 | <10 |
| | 2 | 835,000,000 | <10 | <10 | <10 | <10 | <10 | <10 |
| | 3 | 875,500,000 | <10 | <10 | <10 | <10 | <10 | <10 |

| | | Positive | | | | |
|---|---|---|---|---|---|---|
| Interval | | Control | ESP-1 (.125%) | OP-1 (0.125%) | ESP-1 (0.05%) | OP-1 (0.05%) |
| Inoculum | Replicates | (cfu/ml) | (cfu/ml) | (cfu/ml) | (cfu/ml) | (cfu/ml) |
| Level | | 1500 | 1500 | 1500 | 1500 | 1500 |
| Day 0 | 1 | 790 | <10 | <20 | <20 | <100 |
| | 2 | 805 | <10 | <20 | <20 | <100 |
| | 3 | 920 | <10 | <20 | <20 | <20 |
| Day 5 | 1 | 596,500,000 | <100 | 69,000 | 95,000 | 1,600,000 |
| | 2 | 835,000,000 | <100 | 78,000 | 101,500 | 1,350,000 |
| | 3 | 875,500,000 | <100 | 58,500 | 111,100 | 1,800,000 |

TABLE 9
EFFICACY OF PRESERVATIVES CHALLENGED WITH PSEUDOMONAS ON FOOD (CHICKEN MEAT & SKIN)

| | | Positive | | | | | | |
|---|---|---|---|---|---|---|---|---|
| Interval | | Control | ESP-1 (1%) | OP-1 (1%) | ESP-1 (0.5%) | OP-1 (0.5%) | ESP-1 (0.25%) | OP-1 (0.25%) |
| Inoculum | Replicates | (cfu/ml) | (cfu/ml) | (cfu/ml) | (cfu/ml) | (cfu/ml) | (cfu/ml) | (cfu/ml) |
| Level | | 50 | 50 | 50 | 50 | 50 | 50 | 50 |
| Day 0 | 1 | 50 | 0 | 0 | 0 | 0 | 0 | 0 |
| | 2 | 50 | 0 | 0 | 0 | 0 | 0 | 0 |
| | 3 | 45 | 0 | 0 | 0 | 0 | 0 | 0 |
| Day 5 | 1 | 650,500,000 | 0 | 0 | 0 | 0 | 0 | 0 |
| | 2 | 672,100,000 | 0 | 0 | 0 | 0 | 0 | 0 |
| | 3 | 592,500,000 | 0 | 0 | 0 | 0 | 0 | 0 |

| | | Positive | | | | |
|---|---|---|---|---|---|---|
| Interval | | Control | ESP-1 (.125%) | OP-1 (0.125%) | ESP-1 (0.05%) | OP-1 (0.05%) |
| Inoculum | Replicates | (cfu/ml) | (cfu/ml) | (cfu/ml) | (cfu/ml) | (cfu/ml) |
| Level | | 50 | 50 | 50 | 50 | 50 |
| Day 0 | 1 | 50 | 0 | 0 | 0 | <20 |
| | 2 | 50 | 0 | 0 | 0 | <20 |
| | 3 | 45 | 0 | 0 | 0 | <20 |
| Day 5 | 1 | 650,500,000 | <20 | 120 | 50 | 140,000 |
| | 2 | 672,100,000 | <20 | 125 | 21 | 120,000 |
| | 3 | 592,500,000 | <20 | 130 | 20 | 135,000 |

TABLE 10
EFFICACY OF PRESERVATIVES CHALLENGED WITH PSEUDOMONAS ON FOOD (FISH, WHITE & SKIN)

| | | Positive | | | | | | |
|---|---|---|---|---|---|---|---|---|
| Interval | | Control | ESP-1 (1%) | OP-1 (1%) | ESP-1 (0.5%) | OP-1 (0.5%) | ESP-1 (0.25%) | OP-1 (0.25%) |
| Inoculum | Replicates | (cfu/ml) | (cfu/ml) | (cfu/ml) | (cfu/ml) | (cfu/ml) | (cfu/ml) | (cfu/ml) |
| Level | | 50 | 50 | 50 | 50 | 50 | 50 | 50 |
| Day 0 | 1 | 43 | 0 | 0 | 0 | 0 | 0 | 0 |
| | 2 | 50 | 0 | 0 | 0 | 0 | 0 | 0 |
| | 3 | 48 | 0 | 0 | 0 | 0 | 0 | 0 |
| Day 5 | 1 | 472,100,000 | 0 | 0 | 0 | 0 | 0 | 0 |
| | 2 | 510,500,000 | 0 | 0 | 0 | 0 | 0 | 0 |
| | 3 | 535,300,000 | 0 | 0 | 0 | 0 | 0 | 0 |

| | | Positive | | | | |
|---|---|---|---|---|---|---|
| Interval | | Control | ESP-1 (.125%) | OP-1 (0.125%) | ESP-1 (0.05%) | OP-1 (0.05%) |
| Inoculum | Replicates | (cfu/ml) | (cfu/ml) | (cfu/ml) | (cfu/ml) | (cfu/ml) |
| Level | | 50 | 50 | 50 | 50 | 50 |
| Day 0 | 1 | 43 | 0 | 0 | 0 | <20 |
| | 2 | 50 | 0 | 1 | 0 | 26 |
| | 3 | 48 | 0 | 3 | 0 | 23 |
| Day 5 | 1 | 472,100,000 | 0 | 110 | 39 | 162,100 |
| | 2 | 510,500,000 | <10 | 105 | 31 | 139,200 |
| | 3 | 535,300,000 | <10 | 96 | 22 | 118,500 |

TABLE 11
EFFICACY OF PRESERVATIVES CHALLENGED WITH YEAST ON FOOD (CHEESE CHEDDAR)

| | | Positive | | | | | | |
|---|---|---|---|---|---|---|---|---|
| Interval | | Control | ESP-1 (1%) | OP-1 (1%) | ESP-1 (0.5%) | OP-1 (0.5%) | ESP-1 (0.25%) | OP-1 (0.25%) |
| Inoculum | Replicates | (cfu/ml) | (cfu/ml) | (cfu/ml) | (cfu/ml) | (cfu/ml) | (cfu/ml) | (cfu/ml) |
| Level | | 200 | 200 | 200 | 200 | 200 | 200 | 200 |
| Day 0 | 1 | 198 | 18 | 26 | 15 | 25 | 22 | 39 |
| | 2 | 159 | 22 | 31 | 19 | 35 | 29 | 40 |
| | 3 | 168 | 19 | 23 | 21 | 32 | 34 | 45 |
| Day 5 | 1 | 15,100,000 | <10 | <10 | <10 | <10 | <10 | <10 |
| | 2 | 10,500,000 | <10 | <10 | <10 | <10 | <10 | <10 |
| | 3 | 12,800,000 | <10 | <10 | <10 | <10 | <10 | <10 |

| | | Positive | | | | |
|---|---|---|---|---|---|---|
| Interval | | Control | ESP-1 (.125%) | OP-1 (0.125%) | ESP-1 (0.05%) | OP-1 (0.05%) |
| Inoculum | Replicates | (cfu/ml) | (cfu/ml) | (cfu/ml) | (cfu/ml) | (cfu/ml) |
| Level | | 200 | 200 | 200 | 200 | 200 |
| Day 0 | 1 | 198 | 22 | 32 | 35 | 129 |
| | 2 | 159 | 24 | 31 | 29 | 135 |
| | 3 | 168 | 25 | 52 | 31 | 126 |
| Day 5 | 1 | 15,100,000 | <10 | 129 | 105 | 69,100 |
| | 2 | 10,500,000 | <10 | 135 | 119 | 115,500 |
| | 3 | 12,800,000 | <10 | 144 | 102 | 53,500 |

TABLE 12
EFFICACY OF PRESERVATIVES CHALLENGED WITH ESCHERICHIA COLI (0157-H7) ON FOOD (BEEF)

| | | Positive | | | | | | |
|---|---|---|---|---|---|---|---|---|
| Interval | | Control | ESP-1 (1%) | OP-1 (1%) | ESP-1 (0.5%) | OP-1 (0.5%) | ESP-1 (0.25%) | OP-1 (0.25%) |
| Inoculum | Replicates | (cfu/ml) | (cfu/ml) | (cfu/ml) | (cfu/ml) | (cfu/ml) | (cfu/ml) | (cfu/ml) |
| Level | | 100 | 100 | 100 | 100 | 100 | 100 | 100 |
| Day 0 | 1 | 75 | <10 | <10 | <10 | <10 | <10 | <10 |
| | 2 | 88 | <10 | <10 | <10 | <10 | <10 | <10 |
| | 3 | 91 | <10 | <10 | <10 | <10 | <10 | <10 |
| Day 5 | 1 | 653,000,000 | <10 | <10 | <10 | <10 | <10 | <10 |
| | 2 | 575,300,000 | <10 | <10 | <10 | <10 | <5 | <10 |
| | 3 | 429,100,000 | <10 | <10 | <10 | <10 | <5 | <10 |

| | | Positive | | | | |
|---|---|---|---|---|---|---|
| Interval | | Control | ESP-1 (.125%) | OP-1 (0.125%) | ESP-1 (0.05%) | OP-1 (0.05%) |
| Inoculum | Replicates | (cfu/ml) | (cfu/ml) | (cfu/ml) | (cfu/ml) | (cfu/ml) |
| Level | | 100 | 100 | 100 | 100 | 100 |
| Day 0 | 1 | 75 | <10 | <10 | 19 | 105 |
| | 2 | 88 | <10 | 0 | 20 | 110 |
| | 3 | 91 | <10 | <10 | 15 | 105 |
| Day 5 | 1 | 653,000,000 | <10 | <10 | 15,000 | 215,000 |
| | 2 | 575,300,000 | <10 | 0 | 15,800 | 210,000 |
| | 3 | 429,100,000 | <10 | <10 | 14,500 | 262,000 |

### Example 4

### Use of ESP-1 in Chicken Rinse

ESP-1 at 0.08% in distilled water (test rinse) was tested for its ability to inhibit the growth of bacteria on a freshly produced chicken carcass. The test rinse was compared to a control rinse (distilled water only). See Table 13. Each whole chicken was rinsed for 60 seconds (immersed in bucket containing the control rinse or test rinse for 60 seconds), dripped dried, and stored in a Ziploc bag at 32.5° C.-33° C. The results in Table 13 illustrate bacterial growth, or lack thereof, after the amount of time shown in column 2.

| | Amount of | |
|---|---|---|
| | Time Post | |
| Control Rinse | Rinse | Test Rinse |
| Over 50 colony | 72 hours | No bacteria growth |
| forming units | | |
| (CFUs) | | |
| Over 100 CFUs | 144 hours | No bacteria growth |
| Over 200 CFUs | 240 hours | No bacteria growth |

### Example 5

### Use of ESP-1 for Litter Control

Biofilm formation is a dynamic process. Litter-surfaces are constantly being conditioned with poultry waste, which may contain water, lipids, nutrients, and protein. Bacteria may adhere to the litter and form an adherent biofilm. Further, approximately 18% of a chicken's diet is released into the atmosphere after it has been digested and produced and excreted as manure or waste. Still further, ammonia is generated by microbial activity on fecal urea and uric acid in the litter when the litter is moist, for example. The litter may become moist, for example, when chickens increase diet intake of water.

ESP-1 was mixed with water to a final concentration of 0.08% to form a topical spray for chicken house litter. A KMC Poultry House Washer Sprayer was used for mixing and litter treatment. Mixing occurred for 30 minutes. The mixture was then sprayed evenly over the litter to form a coat on the surfaces of the litter. The sprayed litter was then allowed to dry for 24 hours before baby chicks were brought into the houses.

Litter consisting of wood shavings was either pre-sprayed with, or soaked in, the ESP-1 composition and then allowed to drain and/or dry. Pieces of these wood shavings were placed onto lawns of either S. aureus or Salmonella enterica and zones of clearance were observed observed after 24 hours of incubation, indicating that the ESP-1 pre-sprayed or soaked wood shavings are bacteriocidal. Wood shavings, which were not pre-sprayed or soaked in ESP-1, did not exhibit any bacteriocidal characteristics; bacterial lawns grew unimpeded by the shavings.

### Example 6

### Release of Antimicrobial Characteristics in Calcined Eggshells

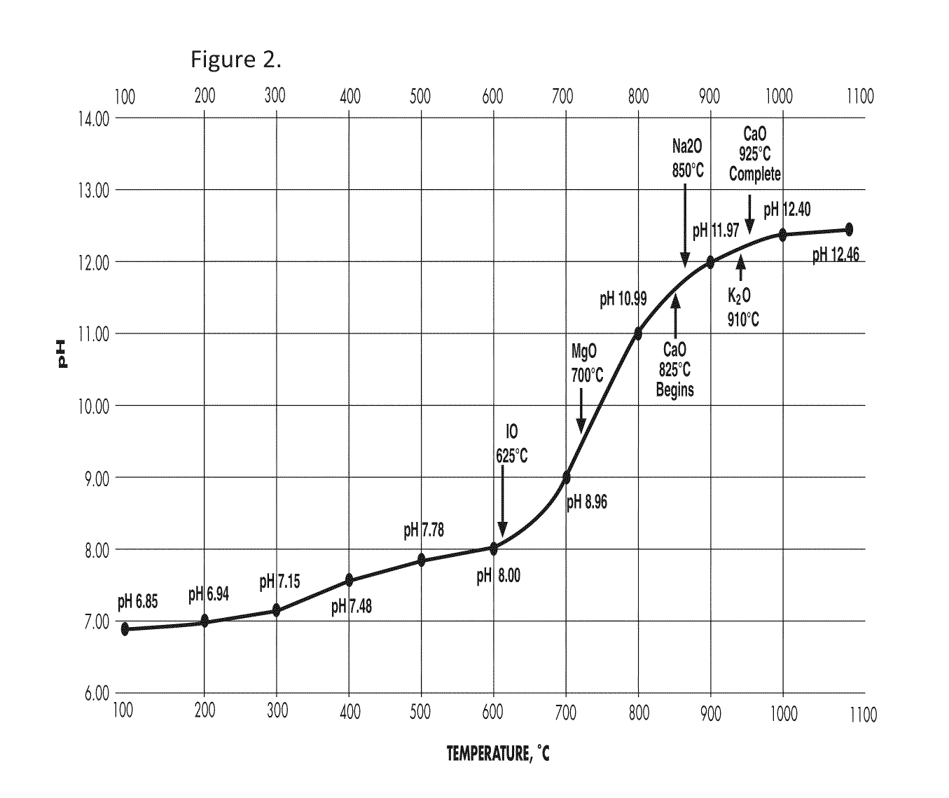

As shown in FIG. 2, the process of calcining the eggshells described herein, can release antimicrobial agents effective against bacterial growth. For example, an eggshell composition was formed as a result of calcining at 625° C. for 1 hour. As a result, the composition contained free iodine, which imparts antimicrobial effects to the composition. The resultant composition had a pH of 8.0. An antimicrobial eggshell composition was also formed by calcining eggshells at 670° C. for 1 hour (pH of about 8.7). It was found that by calcining the eggshells from above 700° C. for more than 1 hour resulted in the vaporization of free iodine and a composition lacking antimicrobial activity resulting from free iodine.

Another eggshell composition was formed as a result of calcining at 700° C. for 1 hour. As a result, the composition contained magnesium oxide, which imparts antimicrobial effects to the composition. The resultant composition had a pH of 8.9.

Several other eggshell compositions were formed as a result of calcining at temperatures of from 850° C. to 925° C. for 1 hour, each having a pH of from 10.5 to 12.3. As a result of the calcining process, the resultant compositions contained calcium oxide, which imparted an antimicrobial effect to each composition.

Yet another eggshell composition was formed as a result of calcining at 850° C. for 1 hour. As a result, the composition contained sodium oxide and calcium oxide, which impart antimicrobial effects to the composition. The resultant composition had a pH of 11.97.

Another eggshell composition was formed as a result of calcining at 910° C. for 1 hour. As a result, the composition contained potassium oxide and calcium oxide, which impart antimicrobial effects to the composition. The resultant composition had a pH of 12.2.

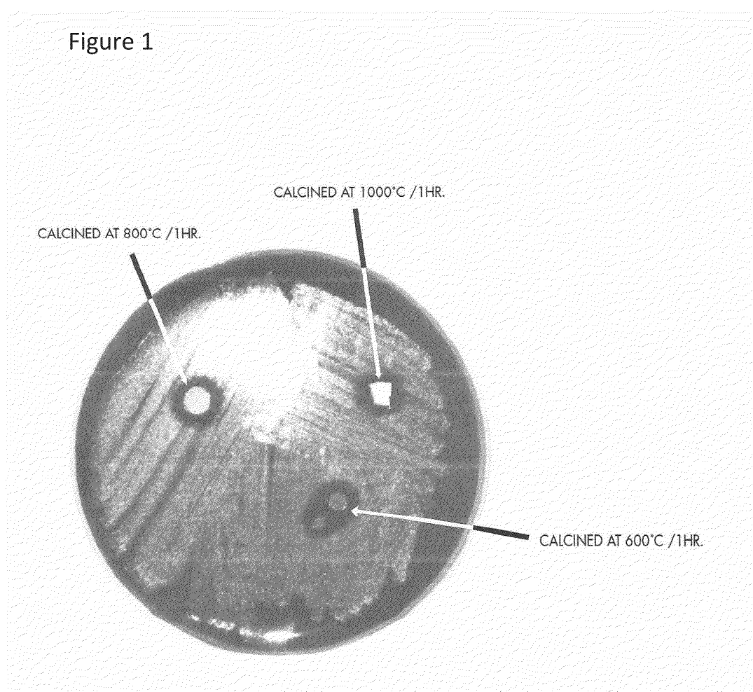

Examples of the bacteriocidal effects of 3 compositions are illustrated in FIG. 1, wherein a lawn of S. aureas was spread onto an agar plate. Three pieces of eggshell were placed onto the lawn, each corresponding to a product produced via a different temperature (600° C. for 1 hour, 800° C. for 1 hour, and 1000° C. for 1 hour). As shown, each eggshell produced a clear zone in the bacterial lawn, thereby indicating each piece as having an antimicrobial capability.

The preferred embodiments of the present invention have been described herein to illustrate the underlying principles of the invention, however, it should be understood that numerous modifications may be made without departing form the spirit and scope of the invention.

We claim:

1. A method of inhibiting the growth of bacteria on an animal comprising contacting the animal with an effective amount of a calcined chicken eggshell composition.

2. The method of claim 1 wherein the contact is direct or indirect.

3. The method of claim 2, wherein the contact is direct.

4. The method of claim 3, wherein the contact is indirect.

5. The method of claim 1, wherein the animal is poultry.

6. The method of claim 5, wherein the poultry is chicken.

7. The method of claim 3, wherein the animal is rinsed with an effective amount of calcined chicken eggshell, wherein the calcined chicken eggshell is in a solution.

8. The method of claim 7, wherein the animal is an animal carcass.

9. The method of claim 8, wherein the animal carcass is a poultry carcass.

10. The method of claim 3, wherein the calcined eggshell is directly applied to the feet of the animal.

11. The method of claim 10, wherein the animal is poultry.

12. The method of claim 11, wherein the poultry is chicken.

13. The method of claim 4, wherein the calcined chicken eggshell is applied to the floor of an animal coup.

14. The method of claim 13, wherein the calcined chicken eggshell is applied to litter in the animal coup.

15. The method of claim 1, wherein an effective amount of the calcined eggshell composition is from 0.03% and 0.5% of calcined eggshell in water.

16. The method of claim 15, wherein the effective amount of the calcined eggshell composition is 0.08% of calcined eggshell in water.

17. The method of claim 1, wherein the calcined eggshell composition comprises free iodine.

18. The method of claim 17, wherein the calcined eggshell composition has a pH of from 8.0 to about 8.7.

19. The method of claim 1, wherein the calcined eggshell composition further comprises an antibiotic, an antiviral, or a combination thereof.

20. The method of claim 8, wherein the carcass is immersed in the calcined eggshell composition.
